(19) United States
(12) Patent Application Publication
(10) Pub. No.: US 2002/0157782 A1
(43) Pub. Date: Oct. 31, 2002

(54) Laminating roller for laminating presses and method for producing laminating rollers

(76) Inventor: Dirk Maes, Lokeren (BE)

Correspondence Address: Pennie & Edmonds, 1667 K Street NW, Washington, DC, 20006, US

(21) Appl. No.: 09/913,601

(22) PCT Filed: Dec. 15, 2000
(86) PCT No.: PCT/EP00/13180

(30) Foreign Application Priority Data
Dec. 17, 1999 (DE) 199 61 365.6

(51) Int. Cl. B41M 1/00

(52) U.S. Cl. 156/280; 156/277; 156/582

(57) ABSTRACT

The invention relates to a laminating roller for laminating presses. The laminating roller has a rigid roller core (20) and a friction layer (24), preferably composed of elastomeric material, which is arranged on the roller core (20). It can be heated by means of a heating element. To simplify the structure of the laminating press, the invention proposes that the heating unit (18) should be arranged between the roller core (20) and the friction layer (24). It is expediently in the form of a heating-resistance element track applied by a thick-film technique with an insulating layer in between.

### FIELD OF INVENTION

The invention relates to a laminating roller for laminating presses with a rigid roller core, with a friction layer, preferably composed of elastomeric material, which is arranged on the roller core and can be heated by means of a heating unit. The invention also relates to a method for producing a laminating roller of this kind and to a laminating press with heatable laminating rollers.

### BACKGROUND OF INVENTION

Laminating presses are used to seal or seal in documents, menus, passes, vehicle documents and similar objects to be laminated in order to protect them against dirtying, water ingress, forgery and destruction. The known laminating presses have a laminating unit which has at least two laminating rollers in pairs, which delimit a laminating slit, and a heating unit for heating the objects to be laminated.

It is the underlying object of the invention to develop a laminating roller and a method for its production which will make it possible to simplify the structure of the laminating press and its assembly.

### SUMMARY OF THE INVENTION

The combinations of features stated in claims 1, 9 and 11 are proposed in order to achieve this object.

The solution according to the invention is based on the idea that the heating unit can be integrated into the laminating roller, thus eliminating the need to use a separate heating unit. To achieve this, the invention proposes that the heating unit should be arranged on the laminating roller between the roller core and the friction layer and should be fixed, preferably in a rigid manner, on the roller core. In this arrangement, the heating unit expediently comprises an electrically heatable resistance element fixed rigidly on the roller core, it being possible for the heating resistance element to be formed as a heating-resistance element track extending at least over part of the length and circumference of the roller core.

In a preferred refinement of the invention, the roller core is formed as a metal tube, on the surface of which is arranged an insulating layer and the heating-resistance element track, which is integrated into the insulating layer or is applied to this layer. The heating unit and the insulating layer are preferably part of a thick-film or hybrid circuit arranged on the roller core. The thick-film or hybrid circuit preferably contains a thermistor which responds to the temperature of the roller and is preferably formed as a PTC resistor. The roller core is furthermore preferably provided on at least one of its ends, which are free of the friction layer, with metallic slip rings which are electrically connected to the thick-film or hybrid circuit and thus, in particular, to the heating-resistance element track.

The measures according to the invention make it possible to construct a laminating press with at least two laminating rollers delimiting a laminating slit in pairs in such a way that at least one of the laminating rollers is combined with a heating element in the above manner. The laminating press expediently contains not only the laminating rollers but also a power supply device for the heating unit, it being possible for the power supply device to have sliding contacts which rest against the slip rings of the laminating roller.

To produce heatable laminating rollers of the above type, it is proposed according to the invention that a roller core formed as a metal tube be provided with an insulating layer, that the insulating layer be coated or printed with a resistor track composed of resistive paste extending at least over part of the circumference and length of the roller core and with conductor tracks which adjoin the resistor track and have slip rings composed of conductive paste which are arranged at the ends and surround the roller core in the circumferential direction, that the resistive and conductive pastes be hardened by firing, and that a friction layer of elastomeric material then be applied to the surface of the roller, leaving the slip rings free. The insulating layer can also be applied in paste form to the metal tube and hardened, preferably at elevated temperature, before the conductive and resistive pastes are applied. The same applies to the elastomeric material, which can be applied in paste form and then hardened, preferably at elevated temperature.

To allow the laminating roller to be heated up in a defined manner by simple means, a preferred refinement of the invention proposes that the conductor tracks and/or resistor tracks be bridged by at least one electrical component, preferably by a thermistor formed as a PTC resistor. The at least one electrical component can be inserted after the application of the friction layer, in the area of the laminating roller which is free of the friction layer. In principle, it is also possible for the at least one electrical component to be inserted before the application of the friction layer into the area subsequently covered by the friction layer. To enable the metal tubes coated with the pasty layers to be handled more easily during production, use is made of gripping members, preferably conical, which are introduced into the end of the tubes to transport them into a firing kiln without coming into contact with the pasty layers.

### BRIEF DESCRIPTION OF THE DRAWINGS

The invention is explained below in greater detail by means of an exemplary embodiment illustrated schematically in the drawing, in which:

FIGS. 1a and b show a diagram of a laminating press with two and four laminating rollers respectively, some of which can be heated;

FIG. 2 shows a section through a heatable laminating roller in diagrammatic representation.

### DESCRIPTION OF THE PREFERRED EMBODIMENT

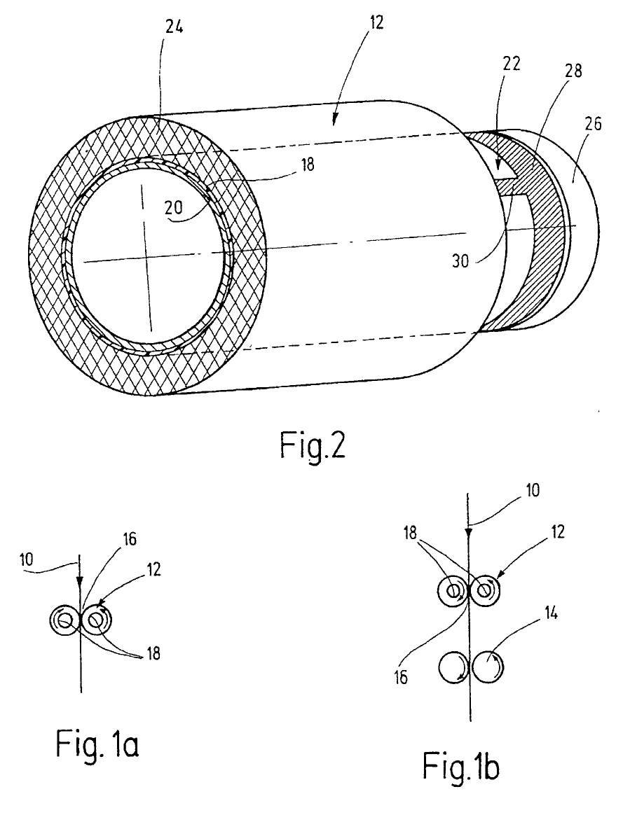

The laminating presses illustrated in FIGS. 1a and b are intended, in particular, for sealing objects 10 to be laminated consisting of flat material, such as paper, board or fabric, between two laminating films, preferably composed of transparent plastic, bonded to one another in the manner of a pouch. On their mutually facing sides, the laminating films are coated over a certain area with a hot-melt adhesive. For this purpose, the laminating press has two or four laminating rollers 12, 14, which rest against one another in pairs and delimit a through-feed slit 16 for the objects 10 to be laminated. Integrated into the laminating rollers 12 there is in addition a heating unit 18, by means of which the roller surface 12 is heated up to such an extent that the hot-melt adhesive on the laminating films is melted, bonding the laminating films to the objects to be laminated under the effect of the contact pressure between the laminating rollers 12, 14.

The structure of the heatable laminating rollers 12 can be seen from FIG. 2. They comprise a dimensionally stable roller core 20 made of steel, which carries a thick film 22 of insulating material, a resistor track arranged on the latter and extending around the circumference and along the length of the laminating roller, and a friction layer 24 made of elastomeric material. The thickness of the roller core 20 in this arrangement is preferably 2 to 3 mm, while the thickness of the thick film is about 0.2 mm and that of the friction layer is about 1 mm. The friction layer is absent from the bearing ends 26 of the laminating rollers 12, the thick film 22 being extended somewhat into the area 26 which is free of the friction layer and there carrying a slip ring 28 for supplying power to the thick-film or hybrid circuit The slip rings 28 are connected electrically to the resistor tracks (not shown) by conductor tracks 30. The temperature at the surface of the heatable laminating rollers 12 is expediently controlled by means of a thermistor (not shown) formed as a PTC resistor inserted into the thick-film circuit. Through a suitable choice of thermistor, it is possible to adjust the temperature at the surface of the laminating rollers 12 very accurately to the softening temperature of the hot-melt adhesive, which is about 85 to 160° C.

In the production of the heatable laminating roller 12, the steel roller core 20 is first of all coated with an insulating paste, which is hardened by firing. The resistor and conductor tracks including the slip rings 28 are then applied in the form of paste to this conductive layer and are fired at elevated temperature. Noble metals such as gold, silver or palladium are used for the conductor tracks 30 and slip rings 28, for example, while a paste composed of metal alloys such as mixtures of silver/palladium and palladium oxide are used for the resistor track.

A paste composed of ceramic glass may be considered for the insulating material, for example, and is hardened by heating. A rubber-elastic plastic is expediently used for the friction layer.

In summary, it may be stated that the invention relates to a laminating roller for laminating presses. The laminating roller has a rigid roller core 20 and a friction layer 24, preferably composed of elastomeric material, arranged on the roller core 20. It can be heated by means of a heating element. To simplify the structure of the laminating press, it is proposed according to the invention that the heating unit 18 should be arranged between the roller core 20 and the friction layer 24. It is expediently in the form of a heating-resistance element track applied by a thick-film technique with an insulating layer in between.

What is claimed is:

1. Laminating roller for a laminating press comprising:
a rigid roller core;
a heating unit comprising a heating-resistance element track composed of resistive paste and conductor tracks adjoining the heating-resistance element track and having slip rings composed of conductive paste, the resistive and conductive pastes being hardenable by firing; and
a friction layer arranged on the roller core and heatable by means of the heating unit, the heating unit being arranged between the roller core and the friction layer.

2. Laminating roller according to claim 1, wherein the friction layer is an elastomeric material.

3. Laminating roller according to claim 1, wherein the heating unit is fixed on the roller core.

4. Laminating roller according to claim 1, wherein the heating unit comprises an electrically heatable resistance element fixed on the roller core.

5. Laminating roller according to claim 4, wherein the heating resistance element is formed as a heating-resistance element track extending over at least part of the length and circumference of the roller core.

6. Laminating roller according to claim 5, wherein the roller core is formed as a metal tube, on the surface of which is arranged an insulating layer and the heating-resistance element track, the track being integrated into the insulating layer or applied to this layer.

7. Laminating roller according to claim 6, wherein the metal tube is made of steel.

8. Laminating roller according to claim 1, wherein the heating unit is part of a thick-film or hybrid circuit arranged on the roller core.

9. Laminating roller according to claim B, wherein the thick-film or hybrid circuit contains a thermistor which responds to the temperature of the roller.

10. Laminating roller according to claim 9, wherein the thermistor is formed as a PTC resistor.

11. Laminating roller according to claim 1, wherein the roller core is provided with metallic slip rings connected electrically to she heating-resistance element track.

12. Laminating roller according to claim 11, wherein the metallic slip rings are provided on the ends of the roller core which are free of the friction layer.

13. Laminating press comprising a pair of laminating rollers delimiting a through-feed slit for objects to be laminated, at least one of the laminating rollers being as claimed in claim 1.

14. Laminating press according to claim 13, further comprising a power supply device for the heating unit, the power supply device having sliding contacts resting against slip rings on the laminating roller.

15. Method of producing heatable laminating rollers, comprising the steps of
forming a roller core as a metal tube;
providing the roller core with an insulating layer;
coating or printing the insulating layer with a heating-resistance element track composed of resistive paste and extending at least over part of the circumference and length of the roller core and conductor tracks adjoining the heating-resistance element track and having slip rings composed of conductive paste and arranged at the ends of the roller core, surrounding the roller core in the circumferential direction;
hardening the resistive and conductive pastes by firing; and
applying a friction layer of elastomeric material to the surface of the roller, leaving the slip rings free.

16. Method according to claim 15, wherein the insulating layer is applied in paste form to the roller core and hardened, before the step of coating or printing the insulating layer.

17. Method according to claim 16, wherein the insulating layer is hardened at elevated temperature.

18. Method according to claim 15, wherein the elastomeric material forming the friction layer is applied in paste form and then hardened.

19. Method according to claim 18, wherein the paste is hardened at elevated temperature.

20. Method according to claim 15, wherein the conductor tracks and/or resistor tracks are bridged by at least one electrical component, preferably by a PTC thermistor.

21. Method according to claim 20, wherein the at least one electrical component is inserted after the step of applying the friction layer, in the area of the laminating roller which is free of the friction layer.

22. Method according to claim 20, wherein the at least one electrical component is inserted before the step of applying the friction layer, into the area to be covered by the friction layer.

23. Method according to claim 15, wherein the roller core coated with pasty substances is grasped by means of gripping members, preferably conical, which are introduced into the end of the tube, and is introduced by means of these gripping members into a kiln and heated there for the purpose of hardening the layers.
